(19) United States
(12) Patent Application Publication
(10) Pub. No.: US 2025/0081278 A1
(43) Pub. Date: Mar. 6, 2025

(54) METHOD FOR PERFORMING USER EQUIPMENT ASSISTANCE INFORMATION TRANSMISSION PROCEDURE, AND USER EQUIPMENT

(71) Applicant: SHARP KABUSHIKI KAISHA, Sakai City, Osaka (JP)

(72) Inventors: NINGJUAN CHANG, Shanghai (CN); RENMAO LIU, Shanghai (CN)

(21) Appl. No.: 18/292,328

(22) PCT Filed: Jul. 26, 2022
(86) PCT No.: PCT/CN2022/107737

§ 371 Date: Jan. 25, 2024

(30) Foreign Application Priority Data
Jul. 27, 2021 (CN) 202110852115.3

(51) Int. Cl. H04W 76/27; H04W 76/15

(52) U.S. Cl. CPC H04W 76/27; H04W 76/15

(57) ABSTRACT

Provided in the present disclosure are a method performed by user equipment and for performing a user equipment assistance information transmission procedure, and user equipment. In an aspect of the present invention, the method includes: when user equipment determines to activate a corresponding secondary cell group due to reception of a secondary cell group activation command related to a secondary cell group or an autonomous determination that the secondary cell group needs to be activated, activating the secondary cell group; and triggering a user equipment assistance information transmission procedure related to the secondary cell group, and transmitting user equipment assistance information to the secondary cell group.

### TECHNICAL FIELD

The present disclosure relates to the technical field of wireless communications. More specifically, the present disclosure relates to a method performed by user equipment and for performing a user equipment assistance information transmission procedure, and corresponding user equipment.

### BACKGROUND

The 3GPP RAN working group is currently conducting a study item of Release 17 (see 3GPP document RP-193249 (New WID on Further Enhancements on Multi-Radio Dual-Connectivity)). In order to further reduce the power consumption of user equipment (UE) in the case of dual connectivity (DC), one of the study objectives is to implement a dynamic secondary cell group (SCG) activation/deactivation mechanism. In an SCG deactivated state, UE may not need to perform some operations of an activated state, such as downlink physical channel monitoring of an associated serving cell in the SCG, related link status detection, or link status reporting, thereby achieving the purpose of saving power. According to current conclusions, UE in the SCG deactivated state may perform SCG-related mobility, including performing a radio resource management (RRM) measurement for SCG mobility, and receive and execute a radio resource control (RRC) reconfiguration message transmitted from the network side and including a reconfiguration with sync, and in addition, the UE in the SCG deactivated state may also accept other RRC reconfigurations for the SCG.

The present disclosure provides a solution to the problem of how to perform UE assistance information reporting when the SCG activation/deactivation mechanism is introduced to an NR system.

### SUMMARY

An objective of embodiments of the present disclosure is to provide a solution to the problem of reporting UE assistance information when an SCG activation/deactivation mechanism is configured (enabled) in an NR system. More specifically, the present disclosure provides a solution to the problems of whether UE needs to report UE assistance information and how to report UE assistance information when an SCG is in a deactivated state, and to the problem of losing or inaccuracy of UE information caused by SCG deactivation. Provided in embodiments of the present disclosure are an information reporting method performed by user equipment and corresponding user equipment.

According to a first aspect of the present disclosure, provided is a method for performing a user equipment assistance information transmission procedure, comprising: when user equipment determines to activate a corresponding secondary cell group due to reception of a secondary cell group activation command related to a secondary cell group or an autonomous determination that the secondary cell group needs to be activated, activating the secondary cell group; and triggering a user equipment assistance information transmission procedure related to the secondary cell group, and transmitting user equipment assistance information to the secondary cell group.

Optionally, before the user equipment assistance information transmission procedure is triggered, the method further comprises: determining whether a triggering condition is satisfied, wherein the triggering a user equipment assistance information transmission procedure related to the secondary cell group comprises: when the triggering condition is satisfied, triggering the user equipment assistance information transmission procedure related to the secondary cell group. The triggering condition comprises: the user equipment having received a user equipment assistance information provision instruction, and at least one of the following: the user equipment has initiated a user equipment assistance information transmission procedure before the secondary cell group is deactivated; the user equipment has not initiated a user equipment assistance information transmission procedure while the secondary cell group is in a deactivated state; and the user equipment has initiated a user equipment assistance information transmission procedure after reception of the user equipment assistance information provision instruction and before the present determination of activating the secondary cell group.

Optionally, the user equipment assistance information transmission procedure may be triggered after the determination of activating the secondary cell group and before activation of the secondary cell group, and the triggering a user equipment assistance information transmission procedure related to the secondary cell group, and transmitting user equipment assistance information to the secondary cell group may comprise: transmitting the user equipment assistance information to the secondary cell group via a resource of a master cell group corresponding to the secondary cell group. Alternatively, the user equipment assistance information transmission procedure is triggered after activation of the secondary cell group, wherein the triggering a user equipment assistance information transmission procedure related to the secondary cell group, and transmitting user equipment assistance information to the secondary cell group may comprise: transmitting the user equipment assistance information to the secondary cell group via a lower layer of an RRC layer of the user equipment.

According to another aspect of the present invention, provided is a method for performing a user equipment assistance information transmission procedure, comprising: determining whether a user equipment assistance information transmission condition is satisfied, determining whether a secondary cell group in which user equipment is located is currently in an activated state; and if the user equipment assistance information transmission condition is satisfied and the secondary cell group is currently in the activated state, triggering a user equipment assistance information transmission procedure related to the secondary cell group, and transmitting user equipment assistance information to the secondary cell group.

Optionally, the user equipment assistance information transmission condition comprises any one of the following: the user equipment has received a user equipment assistance information provision instruction from the secondary cell group; the user equipment has received a user equipment assistance information provision instruction from the secondary cell group, but has not provided corresponding user equipment assistance information to the secondary cell group after reception of the user equipment assistance information provision instruction; and the user equipment assistance information of the user equipment in the secondary cell group has been updated.

Optionally, the user equipment assistance information transmission condition further comprises: a prohibit timer for prohibiting transmission of the user equipment assistance information is not running, the prohibit timer being started each time the user equipment assistance information is transmitted to the secondary group; and/or the user equipment is configured to be not allowed, in a deactivated state of the secondary cell group, to initiate a user equipment assistance information transmission procedure related to the secondary cell group.

According to another aspect of the present invention, further provided is a method performed by user equipment and for performing a user equipment assistance information transmission procedure, comprising: determining whether a secondary cell group is currently in an activated state or an inactive state; triggering a user equipment assistance information transmission procedure related to the secondary cell group; and determining, according to the current state of the secondary cell group, a path for transmitting user equipment assistance information to the secondary cell group, and transmitting the user equipment assistance information to the secondary cell group via the determined path.

Optionally, the determining, according to the current state of the secondary cell group, a path for transmitting user equipment assistance information to the secondary cell group may comprise: if the secondary cell group is currently in the activated state, transmitting the user equipment assistance information to the secondary cell group via a resource of a master cell group corresponding to the secondary cell group; and/or if the secondary cell group is currently in a deactivated state, transmitting the user equipment assistance information to the secondary cell group via a lower layer of an RRC layer of the user equipment.

Optionally, the method according to the third aspect may further comprise: determining whether the user equipment is configured to be not allowed, in the deactivated state of the secondary cell group, to initiate a user equipment assistance information transmission procedure related to the secondary cell group. The triggering a user equipment assistance information transmission procedure related to the secondary cell group is performed after it is determined whether the secondary cell group is currently in the activated state or the inactive state, and the triggering a user equipment assistance information transmission procedure for the secondary cell group may comprise any one of the following: if the user equipment is configured to be not allowed, in the deactivated state of the secondary cell group, to initiate a user equipment assistance information transmission procedure related to the secondary cell group, skipping initiating a user equipment assistance information transmission procedure related to the secondary cell group when the secondary cell group is currently in the deactivated state.

Optionally, the user equipment assistance information comprises user equipment preference information, and the transmitting user equipment assistance information to the secondary cell group may comprise: when a corresponding parameter preference information transmission condition is satisfied, transmitting, to the secondary cell group, parameter preference information of a parameter corresponding to the parameter preference information transmission condition by carrying same in a user equipment assistance message.

Optionally, the parameter preference information transmission condition may comprise: the user equipment has a preference for the parameter, and has received a preference provision instruction related to the parameter; the user equipment has a preference for the parameter, and has received a preference provision instruction related to the parameter, but has not provided parameter preference information corresponding to the parameter to the corresponding secondary cell after reception of the preference provision instruction; the parameter preference information of the user equipment in the secondary cell group has been updated; and the parameter preference information of the user equipment in the secondary cell group has been updated, and a prohibit timer for prohibiting transmission of the parameter preference information is not running, the prohibit timer being started each time the parameter preference information is transmitted to the secondary group.

According to another aspect of the present invention, further provided is user equipment, comprising: a processor; and a memory storing instructions, wherein the instructions, when run by the processor, perform the method described above.

In the information reporting method performed by user equipment and corresponding user equipment according to the present disclosure, UE can report more accurate UE information when an SCG activation/deactivation mechanism is configured, avoiding the situation in which outdated UE information is reported or the situation in which UE information fails to be reported, thereby better ensuring quality of service and service continuity of a corresponding service on an SCG.

### BRIEF DESCRIPTION OF THE DRAWINGS

In order to understand the present disclosure and advantages thereof more fully, reference will now be made to the following description made in conjunction with the accompanying drawings.

FIG. 1 is a flowchart of a method performed by user equipment and for performing a user equipment assistance information transmission procedure according to an embodiment of the present invention.

FIG. 2 is a flowchart of a method performed by user equipment and for performing a user equipment assistance information transmission procedure according to an embodiment of the present invention.

FIG. 3 is a flowchart of a method performed by user equipment and for performing a user equipment assistance information transmission procedure according to an embodiment of the present invention.

FIG. 4 is a structural block diagram of user equipment according to an embodiment of the present invention.

In the drawings, identical or similar structures are marked by identical or similar reference numerals.

### DETAILED DESCRIPTION

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion without limitation; the term “or” has an inclusive meaning and means “and/or”.

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those skilled in the art should recognize that various changes and modifications may be made to the embodiments described herein without departing from the scope and spirit of the present disclosure. In addition, the description of the known function and structure is omitted for clarity and simplicity. In addition, the same reference numerals are used for similar functions and operations throughout the accompanying drawings.

A plurality of embodiments according to the present disclosure are specifically described below by using an NR mobile communications system and its subsequent evolved versions as an exemplary application environment. However, it is to be noted that the present disclosure is not limited to the following embodiments, but may be applied to other wireless communications systems. In the present disclosure, unless otherwise specified, the concept of a cell and the concept of a base station are interchangeable. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access (E-UTRA) or an evolved universal terrestrial radio access network (E-UTRAN). In the present disclosure, a cell can also be referred to as a base station, or can be a beam or a transmission point (TRP). “Cancel”, “release”, “delete”, “flush”, and “clear” are interchangeable. “Execute”, “use”, and “apply” are interchangeable. “Configure” and “reconfigure” are interchangeable. “Monitor” and “detect” are interchangeable.

The prior art involved in the embodiment of the present disclosure will be briefly described below.

### Dual Connectivity (DC):

In order to improve the data transmission efficiency of the UE, the UE simultaneously establishes links with two base stations. That is, radio resources used by the UE are provided by different schedulers located in the two base stations. Radio access between the two base stations and the UE may be the same or different Radio Access Technology (RAT). For example, both are NR, or one is NR, and one is LTE, also referred to as evolved universal terrestrial radio access (E-UTRA). In the two base stations, one is referred to as a master node (MN) or an MgNB or an MeNB. A serving cell group under the master node is referred to as a master cell group (MCG). The other is referred to as a secondary node (SN) or an SgNB or an SeNB, and a serving cell group under the secondary node is referred to as a secondary cell group (SCG). When the master node is LTE and the secondary node is NR, DC is referred to as EN-DC (using a 4G core network) or NGEN-DC (using a 5G core network). When the master node and the secondary node are both NR, DC is referred to as NR-DC. An MCG includes one primary cell (PCell) and one or more optional secondary cells (SCells). The PCell operates on a primary frequency, and the UE performs an initial connection setup procedure or a connection re-establishment procedure via the primary frequency. The SCG includes one PSCell and one or more optional SCells. The PSCell refers to an SCG cell that performs random access when the UE performs a reconfiguration with sync procedure or an SCG addition procedure. The PCell and the PSCell are also collectively referred to as special cells (SpCells).

### UE Information Assistance Information Procedure for Release 16:

A UE assistance information (UAI) procedure is initiated by UE, and is used to provide or indicate some UE assistance information (UAI) to a network side, so as to assist the network side in performing further optimized RRC parameter configuration on the UE. This information includes one or a plurality of the following: a time delay budget report of the UE carrying a desired discontinuous reception (DRX) period length increment/decrement of the connected state, overheating assistance information of the UE, in-device coexistence (IDC) assistance information of the UE, a preference for a DRX parameter for power saving, a preference for a maximum aggregate bandwidth for power saving, a preference for the maximum number of secondary component carriers for power saving, a preference for the maximum number of multiple input multiple output (MIMO) layers for power saving, a preference for a minimum scheduling offset of cross-slot scheduling for power saving, a preference for an RRC state, configured grant assistance information for sidelink communication, a preference for provided reference time information, or the like.

The network side enables the above UAI reporting of the UE via configurations in an otherconfig information element. The otherconfig information element includes RRC configurations related to other configurations. In the system of Release 16, the otherconfig information element may be used to configure/enable a delay budget reporting configuration (delayBudgetReportingConfig), an overheating assistance configuration (overheatingAssistanceConfig), an IDC assistance configuration (idc-AssistanceConfig), a DRX preference configuration (drx-PreferenceConfig), a maximum bandwidth preference configuration (maxBW-PreferenceConfig), a maximum component carrier preference configuration (maxCC-PreferenceConfig), a maximum MIMO layer number preference configuration (maxMIMO-LayerPreferenceConfig), a minimum scheduling offset preference configuration (minSchedulingOffsetPreferenceConfig), a release preference configuration (releasePreferenceConfig), a reference time preference reporting configuration (reference TimePreferenceReporting), a Bluetooth name list (btNameList), a wireless local area network name list (wlanNameList), a sensor name list (sensorNameList), an obtaining common location configuration (obtainCommonLocation), a sidelink assistance configuration (sl-AssistanceConfigNR), etc. Each of the above configurations may further include a prohibit timer length configuration corresponding thereto. The inhibit timer is used to limit the UE from frequently transmitting unnecessary UAI. When the UE triggers transmission of a certain item of UAI, the UE starts a prohibit timer corresponding to the item of UAI. During running of the timer, the UE is not allowed to trigger a new UAI procedure associated with the item of UAI. The UE can trigger a UAI procedure only when other triggering conditions are satisfied and the timer is not running.

For UE that has a certain UAI capability and is in the RRC connected state, when the UE is configured to provide the item of UAI but the UE has not transmitted corresponding assistance information, or when the UE determines that the assistance information has changed, the UE may initiate a UAI procedure, include the corresponding item of assistance information in a UE assistance information (UEAssistanceInformation) message, and transmit same to the network side.

Some UAI items are performed depending on the cell group (CG), that is, are configured and reported respectively for a master cell group (MCG) or a secondary cell group (SCG). For UAI of the SCG, otherconfig included in an SCG configuration enables reporting of one or more corresponding UAI items and configures the value of a corresponding prohibit timer. For UE of dual connectivity (DC), when a UE assistance configuration of a triggered UAI procedure is for an SCG, if the UE is configured with signaling radio bearer (SRB) 3, the UE transmits a UEAssistanceInformation message to a secondary node (SN) via SRB3; otherwise, if the UE is not configured with SRB3, the UE embeds the UEAssistanceInformation message in a ULInformationTransferMRDC message, and transmits same to an MCG, that is, submits same to the SN via an access path of the MCG such as SRB1. The above UE assistance configurations, i.e., an SCG configuration item in otherconfig, include fields such as drx-PreferenceConfig, maxBW-PreferenceConfig, max (C-PreferenceConfig, maxMIMO-LayerPreferenceConfig, minSchedulingOffsetPreferenceConfig, btNameList, wlanNameList, sensor NameList, and obtainCommonLocation.

### SCG Activation/Deactivation Mechanism

In the NR system of Release 16, considering the traffic volume change of the UE, power consumption of the UE on one SCell may be reduced by means of deactivating the SCell or changing a bandwidth part (BWP), on which the SCell operates, to a dormant BWP.

In an SCell activation/deactivation mechanism, one or more SCells are activated or deactivated mainly via a Medium Access Control (MAC) control element (CE) or radio resource control signaling. In addition, when an SCell deactivation timer associated with an SCell and running on the UE expires or stops, the UE deactivates the corresponding SCell. When the UE receives an SCell activation/deactivation MAC CE, and if a bit corresponding to an SCell in the MAC CE is set to “1” (that is, indicating activation of the SCell), the UE activates the SCell; if the bit is set to “0” (that is, indicating activation of the SCell), the UE deactivates the SCell. In addition, if an information element (sCellState) for indicating an SCell activated/deactivated state of the SCell in an RRC message received by the UE is set to “activated”, the UE activates the SCell; or otherwise, if sCellState of the SCell in the RRC message received by the UE is not set to “activated”, or is set to “deactivated”, the UE deactivates the SCell. When an SCell is in an activated state, the UE performs normal operations on the SCell, including, for example: transmitting uplink and downlink data normally on the SCell, transmitting a sounding reference signal (SRS) on the SCell, reporting channel state information (CSI) for the SCell, performing physical downlink control channel (PDCCH) monitoring on the SCell, performing PDCCH monitoring for the SCell and physical uplink control channel (PUCCH) transmission on the SCell, etc. When an SCell is deactivated, the UE stops a timer associated with the SCell, deactivates an activated BWP associated with the SCell, removes a configured downlink assignment or a type 2 configured uplink grant (CG) associated with the SCell, suspends a type 1 configured uplink grant, clears a hybrid automatic repeat (HARQ) cache associated with the SCell, and the like. For an SCell in the deactivated state, the UE skips performing normal operations on the SCell, including one or a plurality of the following: skipping transmitting a sounding reference signal (SRS) on the SCell, skipping reporting channel state information (CSI) for the SCell, skipping performing physical downlink control channel (PDCCH) monitoring on the SCell, skipping performing PDCCH monitoring for the SCell, skipping performing physical uplink control channel (PUCCH) transmission on the SCell, and skipping transmitting an uplink shared channel (UL-SCH) and a random access channel (RACH) on the SCell.

In an SCell dormancy mechanism, further power saving is achieved by means of causing the SCell in the activated state to operate on a configured dormant BWP. A base station configures a dormant BWP identifier of an SCell for the UE via RRC signaling. When an activated BWP of an SCell is a dormant BWP, it can be considered that the BWP or the SCell is in a dormant state. The base station notifies, via RRC signaling or downlink control information (DCI) for a BWP change, the UE to operate on a dormant BWP. For a dormant BWP, operations of the UE include one or a plurality of the following: skipping monitoring a PDCCH on the BWP, skipping monitoring a PDCCH for the BWP, skipping receiving a downlink shared channel (DL-SCH) on the BWP, skipping performing CSI measurement for the BWP, stopping all uplink behaviors associated with the SCell, and so on.

However, the above-described power saving mechanism of the SCell is not supported for use on a PSCell. That is, the PSCell in Release 16 is always in the activated state. It is desirable in the current Release 17 to further reduce power consumption caused by unnecessary uplink and downlink transmission or link monitoring when the traffic volume of the UE is low. One method is to introduce an SCG activation/deactivation mechanism, so as to adapt to a dynamically changing UE traffic volume/traffic rate by means of rapidly activating and deactivating an entire SCG cell group. According to current 3GPP conclusions, in the SCG deactivated state, all SCG cells including the PSCell therein are in the deactivated state, and UE skips monitoring the PDCCH channel on the SCG, and skips transmitting a physical uplink shared channel (PUSCH) on the SCG, thereby improving a power utilization rate, and achieving the purpose of power saving. Both an MN and an SN can request deactivation of the SCG, and likewise, both the MN and the SN can request activation of the SCG. In addition, the UE can also request activation of the SCG. For a deactivated SCG, the network side may transmit an SCG activation command to the UE via a channel of the MCG. The SCG activation command refers to RRC signaling, but may also be implemented via lower layer signaling, such as a MAC control element (CE). The current 3GPP has not determined specific content of the SCG activation command, and has not reached conclusions regarding other UE behaviors of the UE on the SCG when in the SCG deactivated state. The SCG activation/deactivation, SCG resume/suspension, and the PSCell activation/deactivation are interchangeable. SCG activation/deactivation command is a general name of the SCG activation command and an SCG deactivation command.

In existing mechanisms, triggering and transmission of the UAI of the SCG are both for the SCG in the activated state, so that whether or how an SCG in the deactivated state transmits UAI to the network side after introduction of the SCG deactivation mechanism becomes a problem about which the present disclosure is concerned. In addition, considering that when UE is deactivated of the SCG, some cached data may be present on the UE if the UE is configured with SRB3, the cached SRB data, such as a measurement report for the SCG, may become invalid after the SCG is activated next time. In order to avoid such a situation, one method is that the UE discards data in an L2 cache when going to the SCG deactivated state upon receiving the SCG deactivation command or when going to an SCG entering state upon receiving the SCG activation command, for example, discarding, on a packet data convergence protocol (PDCP) layer or a radio link control (RLC) layer, a stored corresponding protocol data unit (PDU) or service data unit (SDU). If the UE in this case has UAI that has not been successfully transmitted to the network side, the UAI may be lost. How to prevent UAI from being lost so that the network side can acquire the newest UAI for the SCG has also become a problem about which the present disclosure is concerned.

Several embodiments performed on the UE based on the above problem in the present disclosure are as follows.

### Embodiment 1

This embodiment provides a UAI transmission method performed on UE and for an SCG. In this embodiment, on the basis of an understanding, for an SCG in a deactivated state, in order to save power as much as possible, UE does not perform a corresponding trigger operation determination for UAI of the SCG. The UE determines, by means of determining whether the SCG is in an activated state, whether to trigger a UAI procedure for the SCG. That is, when the UE determines that the SCG is in the deactivated state, the UE does not initiate a UAI procedure for the SCG. By means of the method, the UE may not perform a UAI-related operation when it is determined that the SCG is in the deactivated state, thereby achieving the purpose of power saving.

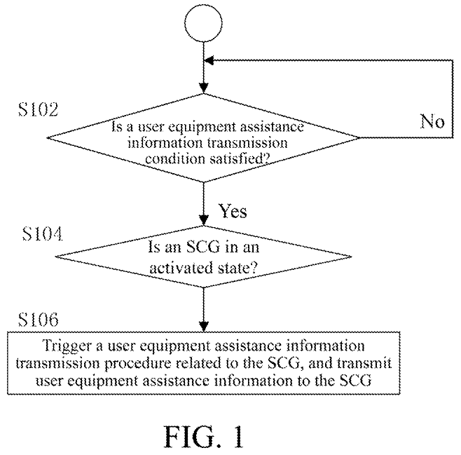

FIG. 1 is a flowchart of a method performed by user equipment and for performing a user equipment assistance information transmission procedure according to this embodiment.

As shown in FIG. 1, in S102, it is determined whether a user equipment assistance information transmission condition is satisfied. The user equipment assistance information transmission condition includes any one of the following: user equipment has received a user equipment assistance information provision instruction from a secondary cell group; the user equipment has received a user equipment assistance information provision instruction from the secondary cell group, but has not provided corresponding user equipment assistance information to the secondary cell group after reception of the user equipment assistance information provision instruction; or the user equipment assistance information of the user equipment in the secondary cell group has been updated.

If the user equipment assistance information transmission condition is satisfied, then in S104, it is determined whether a secondary cell group in which the user equipment is located is currently in an activated state. It should be noted that FIG. 1 shows that the operation of S102 is performed first, and the operation of S104 is performed when the condition in S102 is satisfied, but in practice, the order of the determination operations in S102 and S104 may also be adjusted. For example, it can first be determined whether the secondary cell group is currently in the activated state, and then, when the secondary cell group is currently in the activated state, it is determined whether the user equipment assistance information transmission condition is satisfied. Alternatively, the determination operations of S102 and S104 may also be performed in parallel.

For example, if the UE is configured with one or more UAI items, and if the UE has not transmitted a UEAssistanceInformation message including corresponding UAI after the UE has been configured to provide the UAI, or if the current UAI item is different from corresponding UAI included in a UEAssistanceInformation message transmitted the previous time (that is, UAI updating has occurred), the UE determines whether the SCG is in the activated state. If the SCG is in the activated state, S106 is performed.

The UAI is for the SCG. The SCG being in the activated state is equivalent to the SCG being not in the deactivated state.

Optionally, in addition to the UE performing the above-mentioned determination of whether the SCG is in the activated state, the method further includes determining, by the UE, whether a prohibit timer associated with the UAI item is in a running state. When the prohibit timer is not in the running state, the determination of whether the SCG is in the activated state may be performed.

Optionally, a condition in the step of the UE determining whether the SCG is in the activated state further includes the UE determining that the value of a configuration parameter for enabling, in the SCG deactivated state, UAI transmission for the SCG indicates that UAI transmission for the SCG is not allowed in the SCG deactivated state. The configuration parameter for enabling, in the SCG deactivated state, UAI transmission for the SCG is configured by a network side (a master node or a secondary node). For example, if the parameter is set to “TRUE” or “FALSE” or “0” or “NOT ALLOWED” or “release”, or the parameter is not configured, it is indicated that UAI transmission for the SCG is not allowed in the SCG deactivated state.

If the user equipment assistance information transmission condition is satisfied and the secondary cell group is currently in the activated state, then in S106, a user equipment assistance information transmission procedure related to the secondary cell group is triggered, and user equipment assistance information is transmitted to the secondary cell group. In the step, the UE may perform one or a plurality of the following operations: (1) starting or restarting a corresponding prohibit timer; (2) initiating transmission of a UEAssistanceInformation message so as to provide, to the network side, current information corresponding to the UAI item.

As an example, for a specific UAI item, the UE performs the following UAI transmission method.

Regarding reporting of a DRX parameter preference:
if the UE is configured to provide the DRX parameter preference thereof for the SCG for power saving, then (1) if the UE has a preference for a DRX parameter of the SCG and the UE has not transmitted a UEAssistanceInformation message for the SCG and including a DRX preference drx-Preference after the UE is configured to provide the DRX parameter preference thereof for the SCG for power saving; or (2) current drx-Preference information of the SCG is different from drx-Preference of the SCG in a UEAssistanceInformation message transmitted the previous time, and a corresponding SCG prohibit timer T346a is not running; and if the UE determines that the SCG is in the activated state, then the UE performs: (1) starting the corresponding SCG prohibit timer T346a, the value of the timer being set to the value of a drx-PreferenceProhibitTimer parameter of the SCG; and (2) initiating transmission of a UEAssistanceInformation message so as to provide current drx-Preference to the network side.

Regarding reporting of a maximum aggregate bandwidth preference:
if the UE is configured to provide the maximum aggregate bandwidth preference thereof for the SCG for power saving, then (1) if the UE has a preference for a maximum aggregate bandwidth of the SCG and the UE has not transmitted a UEAssistanceInformation message for the SCG and including maxBW-Preference after the UE is configured to provide the maximum aggregate bandwidth preference thereof for the SCG for power saving; or (2) current maxBW-Preference information of the SCG is different from maxBW-Preference of the SCG in a UEAssistanceInformation message transmitted the previous time, and a corresponding SCG prohibit timer T346b is not running; and if the UE determines that the SCG is in the activated state, then the UE performs: (1) starting the corresponding SCG prohibit timer T346b, the value of the timer being set to the value of a maxBW-PreferenceProhibitTimer parameter of the SCG; and (2) initiating transmission of a UEAssistanceInformation message so as to provide current maxBW-Preference to the network side.

Regarding reporting of a preference for the maximum number of secondary component carriers:
if the UE is configured to provide the preference thereof for the maximum number of secondary component carriers of the SCG for power saving, then (1) if the UE has a preference for the maximum number of secondary component carriers of the SCG and the UE has not transmitted a UEAssistanceInformation message for the SCG and including maxCC-Preference after the UE is configured to provide the preference thereof for the maximum number of secondary component carriers of the SCG for power saving; or (2) current maxCC-Preference information of the SCG is different from information in maxCC-Preference of the SCG in a UEAssistanceInformation message transmitted the previous time, and a corresponding SCG prohibit timer T346c is not running; and if the UE determines that the SCG is in the activated state, then the UE performs: (1) starting the corresponding SCG prohibit timer T346c, the value of the timer being set to the value of a maxCC-PreferenceProhibitTimer parameter of the SCG; and (2) initiating transmission of a UEAssistanceInformation message so as to provide current maxCC-Preference to the network side.

Regarding reporting of a preference for the maximum number of MIMO layers:
if the UE is configured to provide the preference thereof for the maximum number of MIMO layers of the SCG for power saving, then (1) if the UE has a preference for the maximum number of MIMO layers of the SCG and the UE has not transmitted a UEAssistanceInformation message for the SCG and including maxMIMO-LayerPreference after the UE is configured to provide the preference thereof for the maximum number of MIMO layers of the SCG for power saving; or (2) current maxMIMO-LayerPreference information of the SCG is different from information in maxMIMO-LayerPreference of the SCG in a UEAssistanceInformation message transmitted the previous time, and a corresponding SCG prohibit timer T346d is not running; and if the UE determines that the SCG is in the activated state, then the UE performs: (1) starting the corresponding SCG prohibit timer T346d, the value of the timer being set to the value of a maxMIMO-LayerPreferenceProhibitTimer parameter of the SCG; and (2) initiating transmission of a UEAssistanceInformation message so as to provide current maxMIMO-LayerPreference to the network side.

Regarding reporting of a preference for a minimum scheduling offset of cross-slot scheduling:
if the UE is configured to provide the preference thereof for the minimum scheduling offset of cross-slot scheduling of the SCG for power saving, then (1) if the UE has a preference for the minimum scheduling offset of cross-slot scheduling of the SCG and the UE has not transmitted a UEAssistanceInformation message for the SCG and including minSchedulingOffsetPreference after the UE is configured to provide the preference thereof for the minimum scheduling offset of cross-slot scheduling of the SCG for power saving; or (2) current minSchedulingOffsetPreference information of the SCG is different from information in minSchedulingOffsetPreference of the SCG in a UEAssistanceInformation message transmitted the previous time, and a corresponding SCG prohibit timer T346e is not running; and if the UE determines that the SCG is in the activated state, then the UE performs: (1) starting the corresponding SCG prohibit timer T346e, the value of the timer being set to the value of a minSchedulingOffsetPreferenceProhibitTimer parameter of the SCG; and (2) initiating transmission of a UEAssistanceInformation message so as to provide current minSchedulingOffsetPreference to the network side.

### Embodiment 2

This embodiment provides a UAI transmission method performed on UE and for an SCG. In this embodiment, when a UAI procedure for an SCG is triggered, UE determines, by means of determining whether the SCG is in an activated state, by which type of path UAI for the SCG is transmitted to a network side SN. In this embodiment, UE in an SCG deactivated state may also report newest UAI information to the SN via a path of an MCG, so that the SCG may learn the UAI information and use same for an RRC parameter configuration thereof. The SCG may select to issue an RRC reconfiguration message for the SCG in the deactivated state so as to update an SCG configuration on the UE, so that the SCG configuration on the UE can be optimized to the maximum extent.

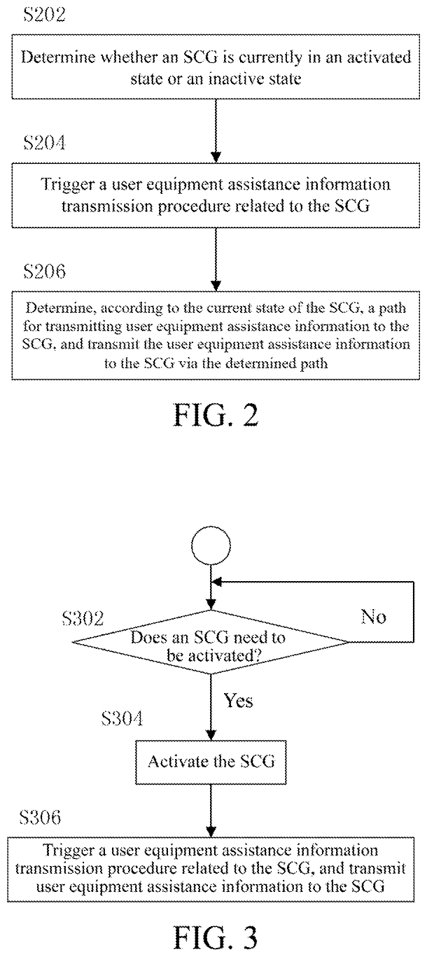

FIG. 2 is a flowchart of a method performed by user equipment and for performing a user equipment assistance information transmission procedure according to this embodiment.

As shown in FIG. 2, in S202, it is determined whether an SCG is currently in an activated state or an inactive state, and in S204, a user equipment assistance information transmission procedure for the SCG is triggered. For UE in dual connectivity, if SRB3 is configured, the UE determines whether the SCG is in the activated state.

In S206, the UE may determine, according to the current state of the SCG, a path for transmitting user equipment assistance information to the SCG, and transmit the user equipment assistance information to the SCG via the determined path.

Specifically, if the SCG is in the activated state, then the UE performs step 206A; otherwise, if the SCG is in a deactivated state, then the UE performs step 206B.

The SCG being in the activated state is equivalent to the SCG being not in the deactivated state. The SCG being in the activated state may also be understood as SRB3 not being suspended. The SCG being in the deactivated state may also be understood as SRB3 being suspended.

Step 206A: submitting a UEAssistanceInformation message to a lower layer via SRB3 for transmission.

The lower layer refers to L2 or L1 below RRC in a protocol stack architecture, such as a PDCP, RLC, Medium Access Control (MAC), or physical layer.

Step 206B: submitting the UEAssistanceInformation message embedded in a ULInformationTransferMRDC message via an MCG for transmission.

Optionally, the DC is EN-DC, NGEN-DC, or NR-DC. When the DC is EN-DC or NGEN-DC, the ULInformationTransferMRDC message is an E-UTRA RRC message. When the DC is NR-DC, the ULInformationTransferMRDC is an NR RRC message.

Obviously, before step 1, the method further includes initiating, by the UE, transmission of a UEAssistanceInformation message for the SCG.

Alternatively, S204 may be performed before S202. In this case, before performing the operation of S204, the UE may determine whether the UE is configured to be not allowed, in the deactivated state of the secondary cell group, to initiate a user equipment assistance information transmission procedure related to the secondary cell group. For example, the UE may determine whether the value of a configuration parameter for enabling, in the SCG deactivated state, UAI transmission for the SCG indicates that UAI transmission for the SCG is allowed in the SCG deactivated state.

If the UE is configured to be not allowed to initiate, in the deactivated state, UAI transmission for the SCG, that is, for example, if the value of the above parameter indicates that UAI transmission for the SCG is not allowed in the SCG deactivated state, then UAI transmission for the SCG is not triggered when the SCG is in the deactivated state, and UAI transmission for the SCG is triggered when the SCG is in the activated state, the UEAssistanceInformation message being transmitted via a lower layer of the UE.

If the UE is configured to be allowed to initiate, in the deactivated state, UAI transmission for the SCG, that is, for example, if the value of the above parameter indicates that UAI transmission for the SCG is allowed in the SCG deactivated state, then the UE may further determine, on the basis of the state of the SCG, a path for transmitting the UEAssistanceInformation message to the SCG. That is, the UE initiating transmission of the UEAssistanceInformation message for the SCG is that the UE determines that the SCG is in the deactivated state and the UE determines that the value of a configuration parameter for enabling, in the SCG deactivated state, UAI transmission for the SCG indicates that UAI transmission for the SCG is allowed in the SCG deactivated state. The configuration parameter for enabling, in the SCG deactivated state, UAI transmission for the SCG is configured by a network side (a master node or a secondary node). For example, if the parameter is set to “TRUE” or “FALSE” or “1” or “ALLOWED” or “setup”, or the parameter is not configured, it is indicated that UAI transmission for the SCG is allowed in the SCG deactivated state.

### Embodiment 3

This embodiment provides a UAI procedure triggering and transmission method performed on UE and for an SCG. When UE receives an SCG activation command or the UE autonomously determines to activate an SCG, the UE triggers a UAI procedure for the SCG, and transmits a UEAssistanceInformation message to an SN, so that the network side can promptly acquire newest UE assistance information, thereby optimizing an RRC parameter configuration of the network side for the UE.

FIG. 3 is a flowchart of a method performed by user equipment and for performing a user equipment assistance information transmission procedure according to this embodiment.

As shown in FIG. 3, in S302, it is determined whether an SCG needs to be activated.

If the SCG needs to be activated, then in S304, UE activates the SCG.

The UE activating the SCG may be on the basis of SCG activation signaling received by the UE from the network side, or may be the UE autonomously activating the SCG after determining on the basis of some conditions (for example, the UE determining that uplink data on a bearer associated with the SCG arrives).

When the SCG activation signaling is MAC layer signaling, the UE activating the SCG may be described as an RRC layer receiving an indication of the MAC layer for indicating that the SCG activation signaling is received.

Then, in S306, UE initiates a UAI procedure for the SCG, and initiates transmission of a UEAssistanceInformation message.

Optionally, the UEAssistanceInformation message is submitted to a lower layer via SRB3 for transmission.

Optionally, a UAI item included in a transmission of UAI for the SCG initiated by the UE may be drx-PreferenceConfig, maxBW-PreferenceConfig, maxCC-PreferenceConfig, maxMIMO-LayerPreferenceConfig, minSchedulingOffsetPreferenceConfig, btNameList, wlanNameList, sensorNameList, obtainCommonLocation, and the like.

Optionally, before S302 is performed, it may be determined whether a triggering condition is satisfied. When the triggering condition is satisfied, a user equipment assistance information transmission procedure related to the secondary cell group may be triggered in S302.

Optionally, when the UE determines that the UE is configured to provide the UAI item for the SCG and the UE has initiated transmission of a UEAssistanceInformation message before the SCG is deactivated, the UE initiates a UAI procedure for the SCG, and initiates transmission of a UEAssistanceInformation message. Before the SCG is deactivated refers to a time when or before the last time the SCG was deactivated before the UE activates the SCG in step 1. Optionally, before the SCG is deactivated is within a time period T before the SCG is deactivated. Preferably, T is 100 ms. The SCG is deactivated by the UE on the basis of received SCG deactivation signaling from the network side.

Optionally, when the UE determines that the UE is configured to provide the UAI item for the SCG, and the UE has initiated transmission of a UEAssistanceInformation message before the SCG is deactivated, and a UAI procedure for the SCG has not been initiated or transmission of a UEAssistanceInformation message for the SCG is not initiated in the period when the SCG is in the deactivated state before the SCG is activated in step 1, the UE initiates a UAI procedure for the SCG, and initiates transmission of a UEAssistanceInformation message. If the UE has initiated a UAI procedure before, it is indicated that the SCG needs related UAI information. If no UAI procedure has been initiated when the SCG is in the deactivated state, UAI may be lost, so that in this case, the UE may initiate a UAI procedure for the SCG.

Optionally, when the UE determines that the UE is configured to provide the UAI item for the SCG and the UE has initiated transmission of a UEAssistanceInformation message for the SCG after the UE is configured to provide the UAI item for the SCG, the UE initiates a UAI procedure for the SCG, and initiates transmission of a UEAssistanceInformation message. If the UE has initiated a UAI procedure before, it is indicated that the SCG needs related UAI information, so that in order to ensure that the UAI information is not lost, a UAI procedure may be initiated again.

Optionally, step 2 further includes starting or restarting, by the UE, a prohibit timer associated with related UAI for the SCG, and setting the value of the prohibit timer to a corresponding configured value.

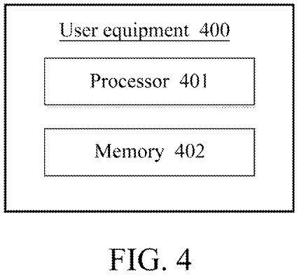

FIG. 4 is a simplified structural block diagram of user equipment (UE) according to the present disclosure. As shown in FIG. 4, the user equipment (UE) 40 includes a processor 401 and a memory 402. The processor 401 may include, for example, a microprocessor, a microcontroller, an embedded processor, and the like. The memory 402 may include, for example, a volatile memory (such as a random access memory (RAM)), a hard disk drive (HDD), a non-volatile memory (such as a flash memory), or other memories. The memory 402 stores program instructions. The instructions, when run by the processor 401, can perform the above method performed by user equipment described in detail in the present disclosure.

In the current 3GPP progress, no conclusion regarding UE behaviors during SCG activation/deactivation has been reached. In the present disclosure, specific behaviors of the UE in the SCG activated state and the SCG deactivated state are not limited, either.

As an example, when the UE changes an SCG from a deactivated state to an activated state, the UE performs one or a plurality of the following operations:
operation 1: activating all SCells in the SCG, which is performed on the MAC layer or the RRC layer;
operation 2: activating a PSCell corresponding to the SCG, which is performed on the MAC layer or the RRC layer;
operation 3: activating a downlink BWP and an uplink BWP respectively indicated by a firstActiveDownlinkBWP-Id information element and/or a firstActiveDownlinkBWP-Id information element, wherein the firstActiveDownlinkBWP-Id information element and the firstActiveDownlinkBWP-Id information element are configured by a network side via RRC signaling (e.g., an RRC reconfiguration message), and are used to indicate an identifier of a downlink/uplink BWP activated when a configuration of the RRC signaling is performed or an identifier of a downlink/uplink BWP used when the MAC layer activates an SCell or a PSCell, which is performed on the MAC layer; and
operation 4: starting or restarting an sCellDeactivationTimer timer associated with the Scell or the PSCell, wherein sCellDeactivationTimer is for control of the activated/deactivated state of the SCell or the PSCell, and when the timer expires, the UE considers that the cell associated therewith is in the deactivated state, and when the timer is running, the UE considers that the cell associated therewith is in the activated state. This is performed on the MAC layer of the UE. In another manner, the operation includes starting or restarting an SCGdeactivationTimer timer associated with the SCG, wherein sCellDeactivationTimer is for control of the activated/deactivated state of the SCG, and when the timer expires, the UE considers that the SCG associated therewith is in the deactivated state, and when the timer is running, the UE considers that the SCG associated therewith is in the activated state. In yet another manner, the operation includes stopping an SCG activation/deactivation timer, wherein the SCG activation/deactivation timer is for control of the activated/deactivated state of the SCG, and when the timer expires, the UE considers that the SCG associated therewith is in the activated state, and the UE performs a state changing operation from the deactivated state to the activated state of the SCG included in this embodiment, and when the timer is running, the UE considers that the SCG associated therewith is in the deactivated state.
Operation 5: initializing or re-initializing a suspended type 1 configured uplink grant associated with the SCell or the PSCell, which is performed on the MAC layer of the UE.

Preferably, the above operations 3 to 5 are performed when firstActiveDownlinkBWP-Id is not set to be a dormant BWP. Optionally, when the SCG activation command is a MAC CE or RRC signaling, the SCG activation command further separately indicates that the activation state of each SCG SCell is activated or deactivated state in addition to indicating that the state of the PSCell/SCG is activated. In this case, the SCells in operation 1 refer to all SCells of which the activation state is indicated to be activated, and the above operations 3 to 5 are also performed for all SCells of which the activation state is indicated to be activated.
Operation 6: resuming all DRBs and SRBs associated with the SCG. An SCG portion of a split bearer is included. This is performed on the RRC layer of the UE.
Operation 7: starting or restarting an uplink time alignment timer timeAlighmentTimer associated with the uplink timing advance group (TAG) for the SCG/PSCell or the PSCell and used for uplink time alignment, which is performed on the MAC layer of the UE.
Operation 8: performing an operation of resetting a MAC entity, wherein preferably, the operation of resetting a MAC entity does not include canceling a triggered buffer status report (BSR) procedure. This is performed on the MAC layer of the UE.
Operation 9: triggering a random access procedure of the PSCell. Optionally, the UE determines, on the basis of random access indication information in an SCG activation command, whether to perform a random access procedure. When the random access indication information in the SCG activation command is present or is set to TRUE or 1, or when a random access parameter in the SCG activation command is configured in the SCG activation command, the UE performs the random access procedure of the PSCell. The random access parameter (a RACH-ConfigDeadicated information element identifier) refers to a physical random access channel (PRACH) time-frequency resource for performing a RACH procedure, a reference signal received power (RSRP) threshold configuration and prioritization parameter (e.g., a ra-Prioritization information element) of a synchronization signal block (SSB)/channel status information reference signal (CSIRS), etc. Optionally, if the uplink time alignment timer associated with the PSCell is in a non-running state, then the UE performs random access, otherwise, the UE does not perform random access.
Operation 10: if the SCG activation command is acquired via a received MAC CE, or if the SCG activation decision is determined by a MAC entity, for example, a BSR is triggered or a random access procedure is triggered, then the MAC entity indicates the SCG activation information to an upper layer (e.g., the RRC layer).
Operation 11: if the SCG activation command is acquired via physical layer signaling DCI, for example, an SCG activation field included in the DCI indicates SCG activation or a BWP identifier included in the DCI indicates that the BWP is not a dormant BWP, the physical layer indicates the SCG activation information or the PSCell activation information or the BWP change information to an upper layer (e.g., the MAC layer or the RRC layer). Preferably, the DCI refers to DCI for a PSCell or an SCell of the SCG, and in this case, the BWP refers to a BWP configured by the PSCell or the SCell.
Operation 12: if the SCG activation command is acquired via received RRC signaling, or if the SCG activation decision is determined by RRC, for example, a CPC execution procedure is triggered, then the RRC layer indicates the SCG activation information to a lower layer (e.g., the MAC layer). The SCG activation information may also be expressed as the PSCell activation information.

Upon receiving the SCG activation command, the UE performs the above operation from the SCG deactivated state to the SCG activated state, or the above related operation is performed when the MAC layer or the RRC layer of the UE receives inter-layer interaction indication information, such as SCG activation indication information, of operations 10 to 12.
Operation 13: starting radio link monitoring (RLM) performed on an SCG Link.
Operation 14: switching from radio resource management (RRM) measurement of relaxed requirements to execution of normal SCG RRM measurement.
Operation 15: starting performing beam failure monitoring and possible beam failure resumption on the SCG link.
Operation 16: starting transmission of an uplink sounding reference signal (SRS).

As an example, a UE operation in the SCG deactivated state includes one or a plurality of the following:
skipping transmission of an SRS on the PSCell and the SCell of the SCG;
skipping reporting of CSI for the PSCell and the SCell of the SCG;
skipping transmission of a UL-SCH on the PSCell and the SCell of the SCG;
skipping transmission of a RACH on the PSCell and the SCell of the SCG;
skipping PDCCH monitoring on the PSCell and the SCell of the SCG;
skipping monitoring of a PDCCH for the PSCell and the SCell of the SCG;
skipping transmission of a PUCCH on the PSCell and the SCell of the SCG;
skipping reception of a UL-SCH on the PSCell and the SCell of the SCG;
skipping performing beam failure detection and a beam failure resumption procedure for the PSCell and/or the SCell of the SCG;
the DRB or SRB associated with the SCG being in a suspended state;
skipping triggering a BSR;
skipping triggering a PHR procedure for a power headroom report;
the PSCell and the SCell of the SCG operating on a dormant BWP corresponding to the cell;
skipping radio link monitoring (RLM) of the SCG link;
skipping normal SCG RRM measurement, but performing radio resource management (RRM) measurement of relaxed requirements;
skipping performing beam failure monitoring and possible beam failure resumption on the SCG link; and
skipping transmission of an uplink sounding reference signal (SRS).

As an example, the UE in the SCG activated state performs a normal communication operation of the PSCell and the SCell of the SCG, including one or a plurality of the following:
transmitting an SRS on the PSCell and the SCell of the SCG;
reporting CSI for the PSCell and the SCell of the SCG;
transmitting a UL-SCH on the PSCell and the SCell of the SCG;
transmitting a RACH on the PSCell and the SCell of the SCG;
monitoring a PDCCH on the PSCell and the SCell of the SCG;
monitoring a PDCCH for the PSCell and the SCell of the SCG;
transmitting a PUCCH on the PSCell and the SCell of the SCG;
receiving a UL-SCH on the PSCell and the SCell of the SCG;
performing beam failure detection and a beam failure resumption procedure for the PSCell and/or the SCell of the SCG;
the DRB or SRB associated with the SCG being in a non-suspended state; or
the PSCell and the SCell of the SCG skipping operating on a dormant BWP corresponding to the cell.

In addition, the SCG being in the activated state defines only that the PSCell is in the activated state or the PSCell does not operate on a dormant BWP, and one or more SCells are allowed to be in the deactivated state or to operate on a dormant BWP. In this case, one or a plurality of the above operations is for the PSCell and the SCell that are in the activated state or the SCell that operates on a non-dormant BWP.

Performing radio link monitoring (RLM) of the SCG link;
performing normal SCG RRM measurement.

Performing beam failure monitoring and possible beam failure resumption on the SCG link.

Performing transmission of an uplink sounding reference signal (SRS).

In the present disclosure, the term “base station” refers to a mobile communication data and control switching center with a larger transmit power and a wider coverage area, and has functions of resource distribution scheduling, data receiving and transmitting, and the like. The term “user equipment” refers to
a user mobile terminal, for example, a terminal device capable of performing wireless communication with a base station or a micro base station, including a mobile phone, a notebook computer, and the like.

The methods and related devices according to the present disclosure have been described above in conjunction with preferred embodiments. It should be understood by those skilled in the art that the methods shown above are only exemplary. The method according to the present disclosure is not limited to steps or sequences shown above. The base station and user equipment shown above may include more modules. For example, the base station and user equipment may further include modules that may be developed or will be developed in the future to be applied to a base station, an MME, or UE. Various identifiers shown above are only exemplary, not for limitation, and the present disclosure is not limited to specific information elements serving as examples of these identifiers. A person skilled in the art could make various alterations and modifications according to the teachings of the illustrated embodiments.

The program running on the device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions may be achieved by reading programs recorded on the recording medium and executing the programs by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-10. (canceled)

11. A User Equipment (UE), comprising:
a processor; and
a memory, wherein the memory stores instructions that cause the processor to:
initiate transmission of a first radio resource control (RRC) message for a Secondary Cell Group (SCG);
if signaling radio bearer 3 (SRB3) is configured and the SCG is not deactivated, submit the first RRC message via SRB3 to lower layers for transmission; and
if the SCG is deactivated, submit the first RRC message via a Master Cell Group (MCG) embedded in a second RRC message for transmission, wherein
the UE is in dual connectivity (DC) state; and the first RRC message is used to indicate UE assistance information to a network.

12. The UE according to claim 11, wherein
the first RRC message is UEAssistanceInformation message, and
the second RRC message is ULInformationTransferMRDC message.

13. A control method in a User Equipment (UE), comprising:
initiating transmission of a first radio resource control (RRC) message for a Secondary Cell Group (SCG);
if signaling radio bearer 3 (SRB3) is configured and the SCG is not deactivated, submitting the first RRC message via SRB3 to lower layers for transmission; and
if the SCG is deactivated, submitting the first RRC message via a Master Cell Group (MCG) embedded in a second RRC message for transmission, wherein
the UE is in dual connectivity (DC) state; and the first RRC message is used to indicate UE assistance information to a network.
